(19) United States
(12) Patent Application Publication
(10) Pub. No.: US 2015/0154615 A1
(43) Pub. Date: Jun. 4, 2015

(54) Entity Identification and Association

(71) Applicant: Bank of America Corporation, Charlotte, NC (US)

(72) Inventors: Samir B. Pawar, Charlotte, NC (US); Hemant Kagade, Charlotte, NC (US); Sudeshna Banerjee, Waxhaw, NC (US); Marc Douglas Halsted, Charlotte, NC (US); Seyamak Amin, Plano, TX (US); Nancy Teter Carrier, Jacksonville, FL (US); Greg D. Farley, Tega Cay, SC (US); Dilip Nair, Charlotte, NC (US); David Neil Joffe, Charlotte, NC (US); David Joa, San Bruno, CA (US)

(73) Assignee: BANK OF AMERICA CORPORATION, Charlotte, NC (US)

(21) Appl. No.: 14/096,433

(22) Filed: Dec. 4, 2013

(51) Int. Cl. G06Q 30/02

(52) U.S. Cl. CPC G06Q 30/0201

(57) ABSTRACT

Systems, methods, computer-readable media, and apparatuses for receiving transaction data associated with a transaction between a first business entity and a second business entity are provided. Data may be extracted from the transaction data to determine a category of the transaction. In some examples, an identity of a first and/or second business entity may be determined from the transaction data and/or additional data. One or more business characteristics of the first or second business entity may be determined based on the identity of the business and the category of the transaction. Accordingly, a network of other business related or having potential to be related to the business entities may be identified (e.g., potential or current vendors, suppliers, service providers, customers, and the like).

### BACKGROUND

Business relationships are an important part of any successful business. Creating and fostering those relationships can be challenging. Identifying companies that have a potential to enter into a business relationship can be difficult. Often, attempts to foster new business relationships are based on limited knowledge or data, rather than information identifying a connection or potential connection between the companies, which can be inefficient.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure relate to methods, computer-readable media, and apparatuses for receiving transaction data associated with a transaction between a first business entity and a second business entity. Data may be extracted from the transaction data to determine a category of the transaction. In some examples, an identity of a first and/or second business entity may be determined from the transaction data and/or additional data. One or more business characteristics of the first or second business entity may be determined based on the identity of the business and the category of the transaction. Accordingly, a network of other business related or having potential to be related to the business entities may be identified (e.g., potential or current vendors, suppliers, service providers, customers, and the like).

### BRIEF DESCRIPTION OF THE DRAWINGS

The present disclosure is illustrated by way of example and not limited in the accompanying figures in which like reference numerals indicate similar elements and in which:

FIG. 1 illustrates an example operating environment in which various aspects of the disclosure may be implemented.

FIG. 2 is an illustrative block diagram of workstations and servers that may be used to implement the processes and functions of certain aspects of the present disclosure according to one or more aspects described herein.

FIG. 3 illustrates an example business entity identification and linking system according to one or more aspects described herein.

FIG. 4 is an example method of identifying one or more business entities according to one or more aspects described herein.

FIG. 5 illustrate an example method of identifying a business entity and providing recommendations based on additional information associated with a network of entities to which the business entity is linked according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized, and that structural and functional modifications may be made, without departing from the scope of the present claimed subject matter.

It is noted that various connections between elements are discussed in the following description. It is noted that these connections are general and, unless specified otherwise, may be direct or indirect, wired or wireless, and that the specification is not intended to be limiting in this respect.

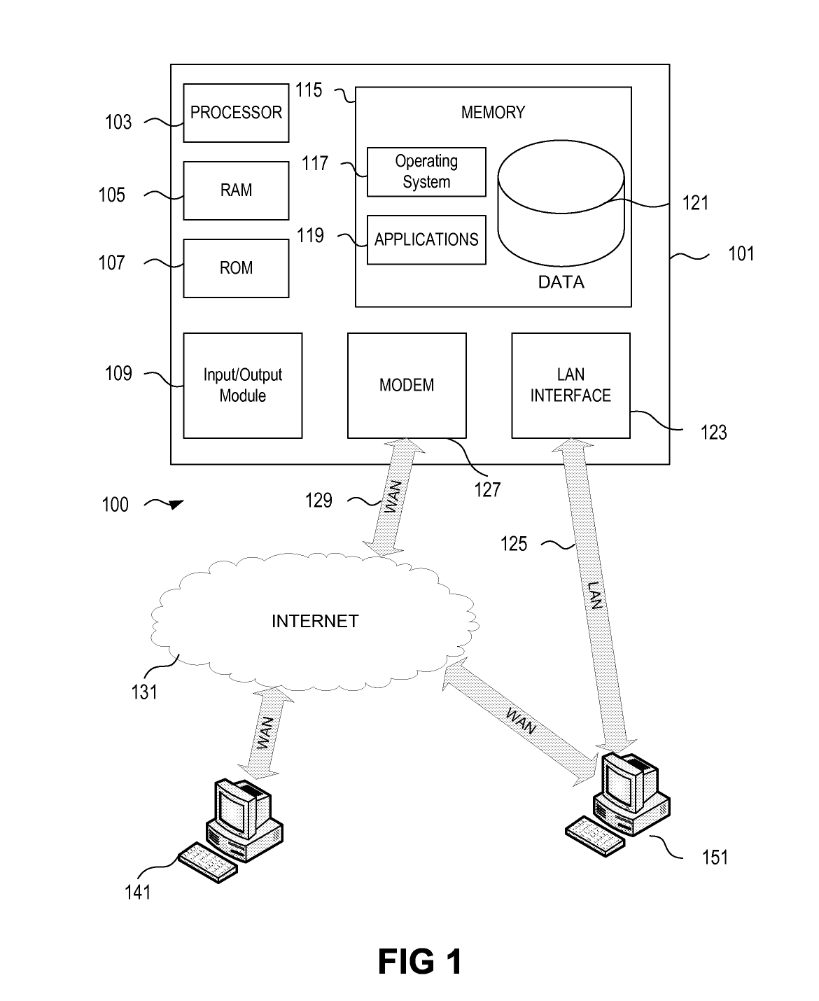

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed arrangements is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141 and 151. Computing devices 141 and 151 may be personal computing devices or servers that include any or all of the elements described above relative to computing device 101. Computing devices 141 or 151 may be a mobile device (e.g., smart phone) communicating over a wireless carrier channel.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

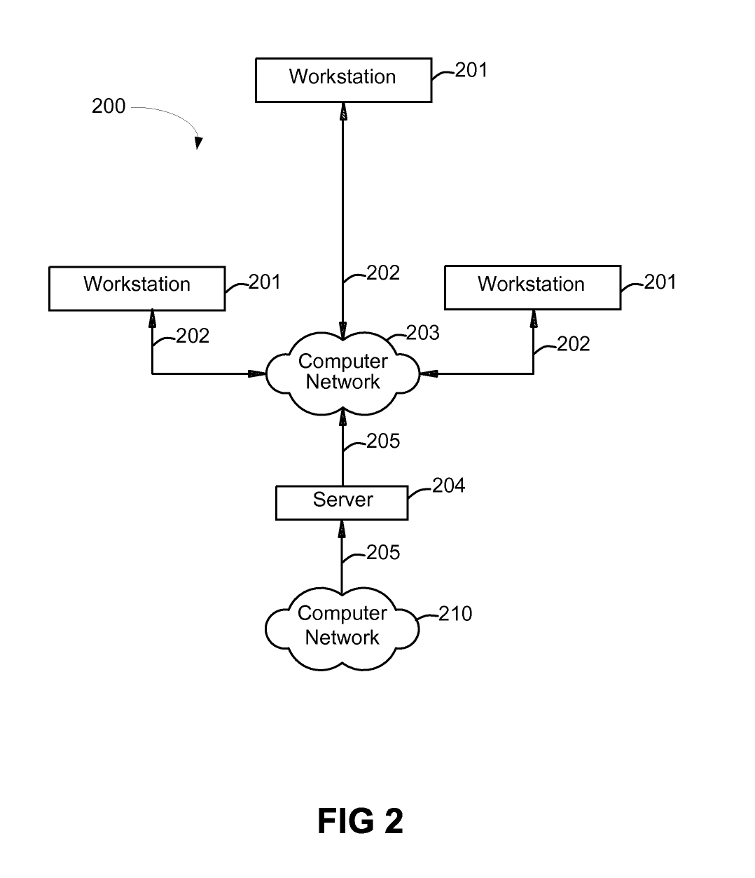

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204 (e.g. network control center), such as network links, dial-up links, wireless links, hard-wired links, as well as network types developed in the future, and the like. A virtual machine may be a software implementation of a computer that executes computer programs as if it were a standalone physical machine.

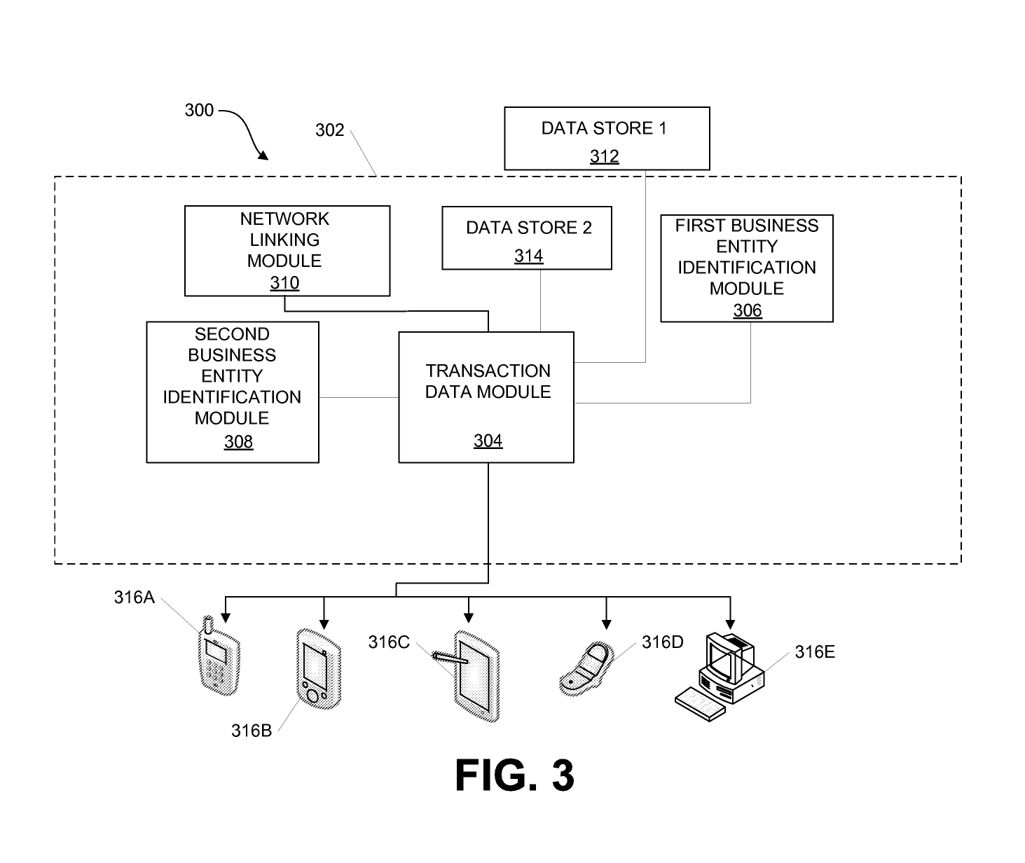

FIG. 3 illustrates one example business entity identification and linking system according to one or more aspects described herein. In some examples, the business entity identification and linking system 300 may be part of, internal to, or associated with an entity 302. The entity 302 corporation, university, government entity, and the like, implementing the business entity identification and linking system 300. In some examples, the entity 302 may be a financial institution, such as a bank. Although various aspects of the disclosure may be described in the context of a financial institution, nothing in the disclosure shall be construed as limiting the business entity identification and linking system to use within or by a financial institution. Rather, the system may be implemented by various other types of entities.

The business entity identification and linking system 300 may include one or more modules that may include hardware and/or software configured to perform various functions within the system 300. For instance, the system 300 may include a transaction data module 304. Transaction data module 304 may receive transaction data, such as from one or more computing devices (e.g., computing devices 316a-316e). In some examples, the transaction data may be associated with a payment, withdrawal, deposit, and the like.

In at least some examples, the transaction data module 304 may receive transaction data from transactions between two or more business entities. For instance, a first business entity may make a payment to a second business entity. In some arrangements, one or more of the business entities involved in the transaction may be associated with (e.g., customers of) the entity 302 (e.g., the financial institution). Accordingly, in some examples, identification of one or more of the business entities may be based on information held by the entity 302, as will be discussed more fully below.

The transaction data module 304 may receive transaction data and extract one or more pieces of data. The data extracted may include a name of a first business entity or party to the transaction and a name of a second business entity or party to the transaction. Although the name of the party to the transaction may be known from the transaction data, the actual identity of the party of business entity may not be known because of insufficient data received from the transaction (e.g., the party or business entity may have a common name such that it could be any number of business entities, the party or business entity may be part of a large corporation having many divisions so the identity of the business entity or nature of the business may not be known from the name, and the like). The extracted data may further include an amount of the transaction, a date of the transaction, account number associated with the transaction, routing number associated with the transaction, and the like. In some arrangements, one or more business entities may not be associated with the entity 302. Accordingly, the identity of that business entity might not be readily available to the entity 302 in conventional systems.

In some examples, the transaction data module 304 may identify or determine a category associated with the transaction. The determined category may provide information related to the business purpose of the transaction. This may aid in identifying one or more business entities associated with the transaction, as will be discussed more fully below.

The business entity identification and linking system 300 may further include a first business entity identification module 306. The first business entity identification module 306 may receive extracted data (e.g., from the transaction data module) and may determine an identity of the first business entity involved in the transaction. In some examples, the first business entity identification module 306 may receive data from one or more data stores, such as data store 1 312 and data store 2 314. The data stores may store additional information about customers of the entity 302, historical transaction information, publicly available information such as names and addresses of businesses, affiliations between businesses, and the like. The data store may be associated with or internal to the entity 302, such as data store 2 314 which may include customer information, historical transaction data, and the like. In other examples, the data store may be external to the entity, such as data store 1 312, that may store publicly available information for one or more businesses. Additional data stores may also be part of the system, as desired. The data stores 312, 314 may be in communication with various modules of the system 300 to provide information.

The first business entity identification module 306 may match transaction data identifying a first business entity with stored data to determine an identity of the first business entity. In some examples, the first business entity may be a customer of or associated with the entity 302 (e.g., the financial institution) and, thus, the identity of the first business entity may be determined from, for example, account information associated with the transaction. That is, the first business entity may have made a payment or received a payment from a second business entity and the payment may be made to or from an account associated with the financial institution. Accordingly, the transaction data would indicate the account and a matching process performed by the first business identification module 306 may determine the identity of the first business entity from the name associated with the account.

The business entity identification and linking system 300 may further include a second business entity identification module 308. The second business entity identification module 308 may receive extracted data (e.g., from the transaction data module 304) and may determine an identity of the second business entity involved in the transaction. In some examples, the second business entity identification module 308 may receive data from one or more data stores, such as data store 1 312 and data store 2 314, as discussed above with respect to the first business entity identification module 306.

As discussed above, in some arrangements, the second business entity might not be associated with or a customer of the entity 302 (e.g., the financial institution). Accordingly, the identity of the second business entity may not be readily available, such as from account information, as with the first business entity. Further, the transaction data alone might not provide sufficient information to determine an identity of the second business entity. For instance, a common name or abbreviation may be provided with the transaction data which may be insufficient to determine the actual business entity involved in the transaction. Thus, additional information may be used (e.g., from data stores 312, 314) to determine an identity of the second business entity.

For instance, the second business entity identification module 308 may match transaction data identifying a second business entity with stored data to determine an identity of the second business entity. For instance, the second business entity may be an entity that is not associated with or a customer of the entity 302 (e.g., the financial institution). Accordingly, the identity of the second business entity may not be readily available, such as from account information, as with the first business entity. Accordingly, additional information may be used to determine the identity of the second business entity. For example, a type of transaction, location of the financial institution associated with the second business entity, transaction history (e.g., payment of a recurring bill to a vendor, utility, and the like), and the like, may be used to determine an identity of the second business entity.

Once the identities of the first business entity and the second business entity are determined, a network of businesses that may be associated with, or may benefit from an association with, the first business entity and/or the second business entity may be determined, such as by the network linking module 310. For instance, the identity of each business entity may be used to determine various business characteristics of each business entity, such as what type of industry each entity is in, what types of relationships (e.g., vendor, supplier, and the like) each entity may have or be looking for, what other entities might be competitors of each entity, and the like. This information may be used to identify a network of related or potential related businesses and to link each business entity to the identified network. Accordingly, the entity 302 may identify potential business relationships, changes in business plan or strategy, anticipated performance of a business entity, and the like, based on the network and other associated information.

For instance, a business entity may be identified as a software company. The network identified for the software company may include marketing entities. An increase in activity between the business entity and a marketing entity (or increased payments made to the marketing entity) may indicate a launch of a new product is approaching. Accordingly, the entity may identify one or more offers to make to the business entity in anticipation of the launch (e.g., an offer of a loan or increased credit, and the like). In other examples, a potential business relationship may be identified and communicated to the business entity (e.g., a potential vendor or supplier that the business entity may benefit from a relationship with). In some examples, the offer, potential relationship, and the like, may be communicated to a business entity via email, short message service (SMS), and the like, provided on a computing device, such as computing devices 316a-316e. For instance, the offer, potential relationship, and the like may be transmitted to a business entity via smart phone 316a, personal digital assistant (PDA) 316b, tablet computer 316c, cell phone 316d or other computing device 316e.

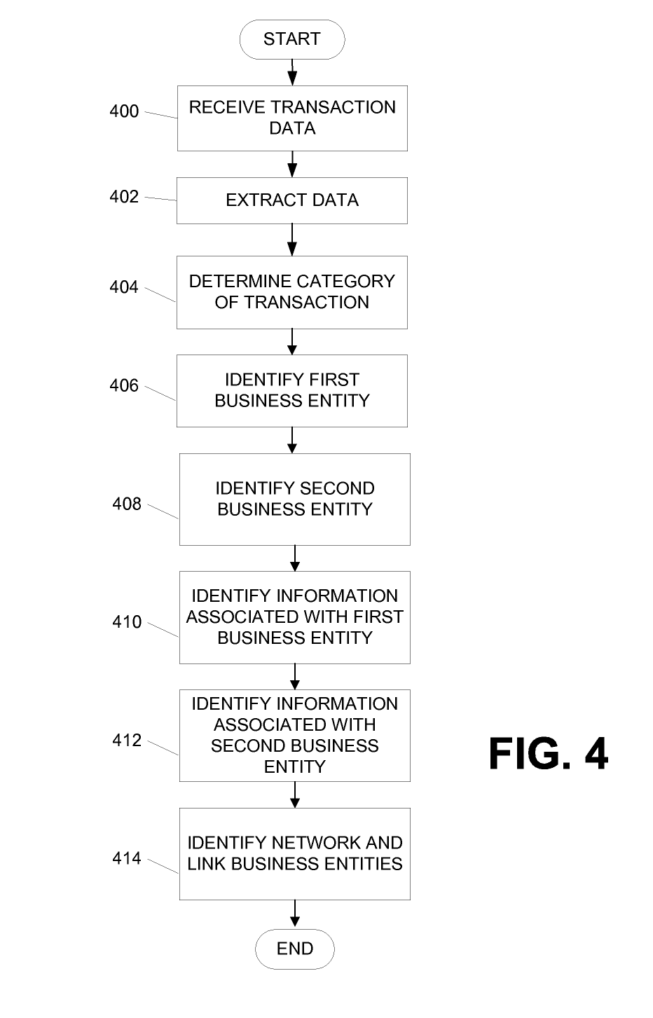

FIG. 4 illustrates one example method of determining an identity of one or more business entities according to one or more aspects described herein. In step 400, transaction data is received. The transaction data may be received from one or more computing devices (e.g., computing devices 316a-316e in FIG. 3). The transaction may be any type of transaction including payment, deposit, and the like, and may be conducted via any of several ways of conducting transactions (e.g., via electronic funds transfer, wire transfer, automated teller machine (ATM), teller, on-line banking system, mobile banking application, and the like). In step 402, data may be extracted from the received transaction data. For instance, information such as an identifier of one or more business entities involved in the transaction (e.g., payor and payee), an amount of the transaction, a date of the transaction, a type of transaction, an account number associated with the transaction, a routing number associated with the transaction, and the like, may be extracted from the transaction data. In step 404, a category of the transaction may be determined.

In step 406, a first business entity that is a party to the transaction may be identified. In some examples, the first business entity may be associated with the financial institution or entity implementing the system. Accordingly, the financial institution may have additional information available to it that may be used to identify the first business entity. For instance, if the transaction included a payment to or from an account of the first business entity, information associated with that account (e.g., account holder name, address, and the like) may be used to identify the first business entity.

In step 408, the second business entity that is a party to the transaction may be identified.

In some examples, the second business entity might not be associated with the financial institution implementing the system. For instance, the second business entity might not have an account with the financial institution implementing the system. Accordingly, it may be more difficult to determine the identity of the second business entity (e.g., because the identity cannot be found via account information). In some examples, the transaction information may provide insufficient information to determine the identity of the second business entity. For instance, the transaction information may include a name associated with the entity. However, that name may be a common name, or may be a name associated with a large corporation having various subsidiaries. Accordingly, the actual identity of the second business entity, including the type of industry it operates in, type of entity, and the like, might not be readily available from the name associated with the transaction information. Accordingly, additional information (such as information from data store 1 and/or data store 2 and/or a category of the transaction) may be used to determine the identity of the second business entity.

For example, information from the transaction, such as name, location of the second business entity, and the like, may be matched with information from data stores. Additionally or alternatively, a transaction history may be used to aid in identifying the second business entity. For instance, if the transaction is a periodic (e.g., monthly) payment, the regularity of the payment may be indicative of the type of payment and may lead to additional identifying information of the second business entity. Various other types of information may be used to determine the identity of the second business entity.

In some examples, first business entity might not be associated with the financial institution while the second business entity is associated with the financial institution. In still other examples, both the first business entity and the second business entity may be associated with the financial institution. Various other combinations (e.g., additional business entities, and the like) may be considered without departing from the invention.

In step 410, information associated with the first business entity, such as one or more business characteristics of the first business entity, may be identified. For instance, the type of industry, type of work, types of business relationships (e.g., vendors, suppliers, and the like) may be identified. In step 412, similar types information (e.g., business characteristics) are identified for the second business entity. In step 414, a network of businesses or each of the first business entity and the second business entity may be identified and each business entity may be linked to the network. For instance, a network of businesses having known business relationships with the first business entity or second business entity may be a part of the network of the respective business entity. In another example, companies or businesses that may have a potential for a business relationship (e.g., potential vendors, suppliers, and the like) may be part of the network of the respective business entity. This information may be communicated to the business entity and/or may be used by individuals outside the business entity to identify potential business relationships, performance aspects of the business entity, and the like. In some arrangements, none of the transaction specific information (e.g., other party to the transaction, amount of the transaction, account(s) associated with the transaction, and the like) would be communicated. Rather, that information would be secured and private. However, that information may be used to identify business relationships and/or a network of businesses and that network, aspects thereof, and the like, may be communicated to the business entity.

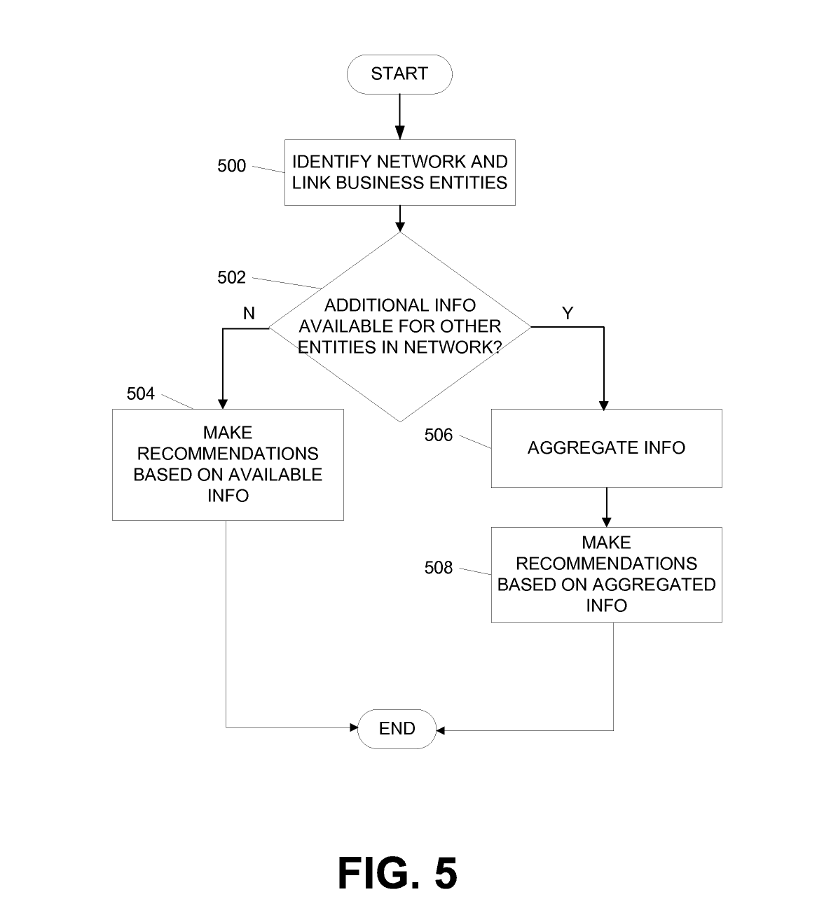

FIG. 5 illustrates another example method of implementing the business entity identification aspect described herein and associations made therefrom. In step 500, a network may be identified for one or more business entities associated with a transaction, and the business entity may be linked to the appropriate network. This process may be similar to the arrangement discussed above (e.g., with reference to FIG. 4). In step 502, a determination is made as to whether additional information is available for other entities within the identified network. For instance, information regarding new business relationships within the network, additional activity between businesses in the network (e.g., an increase in business between one or more entities within the network), and the like.

If, in step 502, additional information is available, that information may be aggregated with the existing information associated with the first or second business entity in step 506. For instance, if two businesses within the network identified for the, for example, second business entity, have a new relationship, that information may be aggregated with the information already obtained and associated with the second business entity (e.g., type of industry, type of work, existing relationships, and the like). This aggregated information may then be used to make recommendations in step 508. For instance, the information may be used to identify a potential new vendor for the second business entity, a potential new customer of the second business entity, and the like.

If, in step 502, no additional information is available, then any recommendations may be made based on the information available and associated with the business entity in step 504. For instance, potential new customers or vendors may be identified from the network of businesses linked to that business entity.

Below is one example scenario of providing recommendations based on additional or aggregate information. It is merely one example scenario and should not be viewed as limiting the disclosure in any way. Various other scenarios, arrangements, and the like may be implemented without departing from the invention.

In one example, Business Entity A may be identified (e.g., via the process of FIG. 4) and may be linked to a network based on the industry, type of work, and the like, determined and associated with Business Entity A. In one example, Business Entity A may be design packaging for products. During time period A, two businesses within the network associated with Business Entity A have shown increased activity. For instance, one business may be a product developer and the other may be a marketing firm. The increased business may be identified from publicly available information (e.g., press releases, and the like) or may be based on transactional data (e.g., data from transactions other than the one leading to the identification of Business Entity A). The increased business activity may indicate a potential new product launch. Accordingly, the potential for new business for Business Entity A may be communicated to Business Entity A in order to possibly secure the design of the packaging of the new product being developed.

As indicated above, this is merely one example of providing a recommendation based on aggregate information. Various other examples may be used without departing from the invention.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable medium. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure. Further, one or more aspects described with respect to one figure or arrangement may be used in conjunction with other aspects associated with another figure or portion of the description.

What is claimed is:

1. An apparatus, comprising:
at least one processor; and
a memory storing computer-readable instructions that, when executed by the at least one processor, cause the apparatus to:
receive transaction data associated with a transaction between a first business entity and a second business entity;
extract data from the received transaction data to determine an identity of the first business entity;
determine, based on the received transaction data, a category of the transaction;
determine, based on the determined identity of the first business entity and the determined category, a plurality of business characteristics of the first business entity; and
identify a network of entities associated with the first business entity based on the plurality of business characteristics associated with the first business entity.

2. The apparatus of claim 1, further including instructions that, when executed, cause the apparatus to:
extract data from the received transaction data to determine an identity of the second business entity;
determine, based on the determined identity of the second business entity and the determined category, a plurality of business characteristics associated with the second business entity; and
identify a network of entities associated with the second business entity based on the plurality of business characteristics associated with the second business entity.

3. The apparatus of claim 2, wherein the apparatus is associated with a financial institution and the first business entity is a customer of the financial institution and the second business entity is not a customer of the financial institution.

4. The apparatus of claim 1, further including instructions that, when executed, cause the apparatus to:
receive additional information associated with an entity within the identified network of entities;
aggregate the additional information with the business characteristics of the first business entity; and
provide a recommendation to the first business entity based on the aggregated information.

5. The apparatus of claim 4, wherein the recommendation includes a potential business relationship between the first business entity and the entity associated with the additional information.

6. The apparatus of claim 1, wherein the network of entities includes a plurality of businesses different from the first business entity.

7. The apparatus of claim 6, wherein the plurality of businesses includes at least one business that does not have an existing relationship with the first business entity.

8. A method, comprising:
receiving, by a business entity identification and linking system having a processor, transaction data associated with a transaction between a first business entity and a second business entity;
extracting, by the business entity identification and linking system, data from the received transaction data to determine an identity of the first business entity;
determining, by the business entity identification and linking system, from the received transaction data, a category of the transaction;
determining, by the business entity identification and linking system, based on the determined identity of the first business entity and the category of the transaction, a plurality of business characteristics of the first business entity; and
identifying, by the business entity identification and linking system, a network of entities associated with the first business entity based on the plurality of business characteristics associated with the first business entity.

9. The method of claim 8, further including:
extracting, by the business entity identification and linking system, data from the received transaction data to determine an identity of the second business entity;
determining, by the business entity identification and linking system, based on the determined identity of the second business entity and the determined category, a plurality of business characteristics associated with the second business entity; and
identifying, by the business entity identification and linking system, a network of entities associated with the second business entity based on the plurality of business characteristics associated with the second business entity.

10. The method of claim 9, wherein the business entity identification and linking system is associated with a financial institution and the first business entity is a customer of the financial institution and the second business entity is not a customer of the financial institution.

11. The method of claim 8, further including:
receiving, by the business entity identification and linking system, additional information associated with an entity within the identified network of entities;
aggregating, by the business entity identification and linking system, the additional information with the business characteristics of the first business entity; and
providing, by the business entity identification and linking system, a recommendation to the first business entity based on the aggregated information.

12. The method of claim 11, wherein the recommendation includes a potential business relationship between the first business entity and the entity associated with the additional information.

13. The method of claim 8, wherein the network of entities includes a plurality of businesses different from the first business entity.

14. The method of claim 13, wherein the plurality of businesses includes at least one business that does not have an existing relationship with the first business entity.

15. One or more non-transitory computer-readable media having computer-executable instructions stored thereon that, when executed, cause at least one computing device to:
receive transaction data associated with a transaction between a first business entity and a second business entity;
extract data from the received transaction data to determine an identity of the first business entity;
determine, from the received transaction data, a category of the transaction;
determine, based on the determined identity of the first business entity and the determined category of the transaction, a plurality of business characteristics of the first business entity; and
identify a network of entities associated with the first business entity based on the plurality of business characteristics associated with the first business entity.

16. The one or more non-transitory computer-readable media of claim 15, further including instructions that, when executed, cause the at least one computing device to:
extract data from the received transaction data to determine an identity of the second business entity;
determine, based on the determined identity of the second business entity and the determined category, a plurality of business characteristics associated with the second business entity; and
identify a network of entities associated with the second business entity based on the plurality of business characteristics associated with the second business entity.

17. The one or more non-transitory computer-readable media of claim 16, wherein the at least one computing device is associated with a financial institution and the first business entity is a customer of the financial institution and the second business entity is not a customer of the financial institution.

18. The one or more non-transitory computer-readable media of claim 15, further including instructions that, when executed, cause the at least one computing device to:
receive additional information associated with an entity within the identified network of entities;
aggregate the additional information with the business characteristics of the first business entity; and
provide a recommendation to the first business entity based on the aggregated information.

19. The one or more non-transitory computer-readable media of claim 18, wherein the recommendation includes a potential business relationship between the first business entity and the entity associated with the additional information.

20. The one or more non-transitory computer-readable media of claim 15, wherein the network of entities includes a plurality of businesses different from the first business entity.
